(19) United States
(12) Patent Application Publication
(10) Pub. No.: US 2020/0047451 A1
(43) Pub. Date: Feb. 13, 2020

(54) FLEXIBLE DISPLAY PANEL MODULE AND DISPLAY APPARATUS

(71) Applicant: BOE TECHNOLOGY GROUP CO., LTD., Beijing (CN)

(72) Inventors: Liming DONG, Beijing (CN); Shangchieh CHU, Beijing (CN); Shiming SHI, Beijing (CN)

(21) Appl. No.: 16/400,955

(22) Filed: May 1, 2019

(30) Foreign Application Priority Data
Aug. 9, 2018 (CN) 201821287607.2

(51) Int. Cl. B32B 3/30

(52) U.S. Cl. CPC B32B 3/30; G09F 9/301

(57) ABSTRACT

Embodiments of the present disclosure provide a flexible display panel module and a display apparatus having the flexible display panel module. The flexible display panel module includes: a flexible display panel including a foldable region and a non-foldable region outside the foldable region; and a supporting assembly disposed on a side of the flexible display panel, connected with the flexible display panel, and including: a foldable portion configured to support the flexible display panel in the foldable region of the flexible display panel; and a non-foldable portion configured to support the flexible display panel in the non-foldable region of the flexible display panel. The foldable portion of the supporting assembly has a less rigidity than the non-foldable portion of the supporting assembly.

### CROSS-REFERENCE TO RELATED APPLICATION

This application claims the benefit of Chinese Patent Application No. 201821287607.2, filed with the State Intellectual Property Office of China on Aug. 9, 2018, the whole disclosure of which is incorporated herein by reference.

### TECHNICAL FIELD

Embodiments of the present disclosure relate to a flexible display panel module and a display apparatus having the flexible display panel module.

### BACKGROUND

A flexible display apparatus has a flexible display panel. Generally, the flexible display panel needs to be supported by another member.

### SUMMARY

Embodiments of the present disclosure provide a flexible display panel module comprising: a flexible display panel comprising a foldable region and a non-foldable region outside the foldable region; and a supporting assembly disposed on a side of the flexible display panel, connected with the flexible display panel, and comprising: a foldable portion configured to support the flexible display panel in the foldable region of the flexible display panel; and a non-foldable portion configured to support the flexible display panel in the non-foldable region of the flexible display panel, wherein the foldable portion of the supporting assembly has a less rigidity than the non-foldable portion of the supporting assembly.

According to embodiments of the present disclosure, the supporting assembly has a flat surface on a side of the supporting assembly facing towards the flexible display panel.

According to embodiments of the present disclosure, the supporting assembly has a flat surface on a side of the supporting assembly facing away from the flexible display panel.

According to embodiments of the present disclosure, an orthogonal projection of the foldable region of the flexible display panel on a plane parallel to the flexible display panel is within an orthogonal projection of the foldable portion of the supporting assembly on the plane.

According to embodiments of the present disclosure, the foldable portion of the supporting assembly comprises a first member; and the non-foldable portion of the supporting assembly comprises a second member connected with the first member, and a modulus of elasticity of the first member is less than a modulus of elasticity of the second member, and is greater than a modulus of elasticity of the flexible display panel.

According to embodiments of the present disclosure, the foldable portion of the supporting assembly further comprises a third member connected with the second member and formed with a plurality of recesses, and each of the plurality of recesses is filled with one said first member and has a depth greater than or equal to a thickness of the first member.

According to embodiments of the present disclosure, openings of the plurality of recesses face towards the flexible display panel, the openings of the plurality of recesses face away from the flexible display panel, or some of the openings of the plurality of recesses face towards the flexible display panel, and the others of the openings of the plurality of recesses face away from the flexible display panel.

According to embodiments of the present disclosure, the first member comprises a plate having a first thickness and the second member comprises a plate having a second thickness; and the first member is connected with the second member in a direction parallel to the flexible display panel.

According to embodiments of the present disclosure, the third member is integrated with the second member.

According to embodiments of the present disclosure, the first member is connected with the flexible display panel in a direction perpendicular to the flexible display panel, and surfaces, respectively facing towards the flexible display panel and facing away from the flexible display panel, of the first member are flush with surfaces, respectively facing towards the flexible display panel and facing away from the flexible display panel, of the second member, respectively.

According to embodiments of the present disclosure, the foldable portion of the supporting assembly further comprises a third member, and a modulus of elasticity of a material of the first member is less than a modulus of elasticity of a material of the third member, and the third member comprises a plate having a third thickness, the third member and the first member are stacked and connected to form a stacked assembly, the stacked assembly is connected with the flexible display panel in a direction perpendicular to the flexible display panel, and the third member is connected with the second member in a direction parallel to the flexible display panel.

According to embodiments of the present disclosure, surfaces, respectively facing towards the flexible display panel and facing away from the flexible display panel, of the stacked assembly are flush with surfaces, respectively facing towards the flexible display panel and facing away from the flexible display panel, of the second member, respectively.

According to embodiments of the present disclosure, the first member is closer to the flexible display panel than the third member, and the first member is connected with the flexible display panel in the foldable region; or the third member is closer to the flexible display panel than the first member, and the third member is connected with the flexible display panel in the foldable region.

According to embodiments of the present disclosure, the second member is formed by folding a plate, the second member has one end connected with the first member in a direction parallel to the flexible display panel, and the other folded end having a curved external surface; and at least one end of the flexible display panel has a groove formed by bending the at least one end, and the other folded end of the second member is fitted in the groove.

According to embodiments of the present disclosure, surfaces, respectively facing towards the flexible display panel and facing away from the flexible display panel, of the first member are flush with surfaces, respectively facing towards the flexible display panel and facing away from the flexible display panel, of the second member, respectively.

According to embodiments of the present disclosure, the foldable portion of the supporting assembly further comprises a third member, and the third member and the first member are stacked, and the second member and the third member are formed by folding a single plate.

According to embodiments of the present disclosure, the folded plate has two folded ends which are aligned with two ends of the flexible display panel, respectively and each of which has a curved external surface; the folded plate has a single-layer portion serving as the third member, and double-layer portions serving as the second member; a recess is defined by the single-layer portion and the double-layer portions respectively located on both sides of the single-layer portion, and the recess is filled with the first member; at least one of the two ends of the flexible display panel has a groove formed by bending the at least one end, and one of the two folded ends of the second member is fitted in the groove; and surfaces, respectively facing towards the flexible display panel and facing away from the flexible display panel, of a stacked assembly formed by stacking the first member and the single-layer portion are flush with surfaces, respectively facing towards the flexible display panel and facing away from the flexible display panel, of each of the double-layer portions, respectively.

According to embodiments of the present disclosure, the first member is connected with the double-layer portions; and the first member is closer to the flexible display panel than the single-layer portion, or the single-layer portion is closer to the flexible display panel than the first member.

According to embodiments of the present disclosure, the flexible display panel module further comprises: a flexible cover plate which is disposed on a side of the flexible display panel facing away from the supporting assembly and is connected with the flexible display panel.

Embodiments of the present disclosure further provide a display apparatus comprising the above flexible display panel module.

Additional aspects and advantages of the present disclosure will be set forth in part in the description which follows and, in part, will be apparent from the description, or may be learned by practice of the present disclosure.

### BRIEF DESCRIPTION OF THE DRAWINGS

The above and/or additional aspects and advantages of the present disclosure will be apparent and more readily appreciated from the following description of embodiments taken in conjunction with the accompanying drawings, in which:

FIG. 1 is a schematic view showing a structure of a flexible display panel module according to an embodiment of the present disclosure;

FIG. 2 is a schematic view showing a structure of a supporting assembly according to an embodiment of the present disclosure;

FIG. 3 is a schematic view showing a structure of a flexible display panel module according to another embodiment of the present disclosure;

FIG. 4 is a schematic view showing a structure of a flexible display panel module according to still another embodiment of the present disclosure;

FIG. 5 is a schematic view showing a structure of a flexible display panel module according to yet another embodiment of the present disclosure;

FIG. 6 is a schematic view showing a structure of a flexible display panel module according to a further embodiment of the present disclosure;

FIG. 7 is a schematic view showing a structure of a flexible display panel module according to a still further embodiment of the present disclosure; and

FIG. 8 is a schematic view showing a partial structure of a flexible display panel module according to an embodiment of the present disclosure.

### DETAILED DESCRIPTION

Reference will now be made in detail to the embodiments of the present disclosure, examples of which are illustrated in the accompanying drawings. The same or similar reference numerals refer to the same or similar elements or elements having same or similar function throughout. Further, if a detailed description of a known technique is unnecessary for the features of the present disclosure illustrated, it will be omitted. The embodiments described below with reference to the accompany drawings are illustrative, are only used to explain the present disclosure, and should not be construed to limit the present disclosure.

It should be noted that unless otherwise defined, all terms (including technical and scientific terms) used herein have the same meaning as commonly understood by one of ordinary skill in the art to which the present disclosure pertains. It should be further understood that terms, such as those defined in commonly used dictionaries, should be interpreted as having meaning that is consistent with their meaning in the context of the relevant art, and should not be interpreted in an idealized or overly formal sense, unless expressly so defined herein.

A further description of the present disclosure will be made as below with reference to embodiments of the present disclosure taken in conjunction with the accompanying drawings.

Embodiments of the present disclosure provide a flexible display panel module. The flexible display panel module includes: a flexible display panel and a supporting assembly disposed on a side of the flexible display panel and connected with the flexible display panel.

The flexible display panel includes a foldable region and a non-foldable region outside the foldable region. The supporting assembly includes a first member and a second member. The first member faces the foldable region. The second member faces the non-foldable region; or the supporting assembly further includes a third member, the second member faces the non-foldable region and the third member faces the foldable region. A modulus of elasticity of the first member is less than a modulus of elasticity of the second member or of each of the second member and the third member, and is greater than a modulus of elasticity of the flexible display panel. The second member and the third member may be integrated or may be formed by a single plate.

In the embodiments of the present disclosure, the modulus of elasticity of each of the first member and the second member of the supporting assembly is greater than the modulus of elasticity of the flexible display panel, or the modulus of elasticity of each of the first member, the second member and the third member is greater than the modulus of elasticity of the flexible display panel, so that the supporting assembly has a greater rigidity and a greater elastic restoring force than the flexible display panel. Thereby, the supporting assembly effectively supports the flexible display panel, helps the flexible display panel absorb a greater impact, increases an impact resistance of the flexible display panel, and facilitates maintaining a flatness and a resilience of the flexible display panel in an unfolded state. The modulus of elasticity of the first member is less than the modulus of elasticity of the second member or the modulus of elasticity of each of the second member and the third member, ensuring that the first member has a great flexibility. In the embodiments of the present disclosure, the first member may face the foldable region of the flexible display panel, or each of the first member and the third member may face the foldable region of the flexible display panel. In both cases, due to the presence of the first member, the portion of the supporting assembly facing the foldable region of the flexible display panel has a greater flexibility than the second member or each of the second member and the third member, in addition to having a certain rigidity and a certain elastic restoring force (i.e. a compromise between the rigidity and elastic restoring force and the flexibility is made). Thereby, in a process of repeatedly unfolding and folding the flexible display panel, a contact stress between the flexible display panel and the supporting assembly can be effectively reduced, the flexible display panel is prevented from being subjected to a large stress in the folding process, a plastic deformation of the flexible display panel in the foldable region is reduced, a probability of damaging the flexible display panel is decreased, and a display failure of the flexible display panel is prevented.

Further, in a possess of a change of the flexible display panel from a folded state to an unfolded state, the flexible display panel can be prevented from wrinkling in the non-foldable region since the second member has a great resistance to deformation, and the second member itself and the flexible display panel can be sufficiently unfolded due to the large elastic restoring force of the second member, preventing the flexible display panel from wrinkling in the foldable region. As a result, the flexible display panel always has a great flatness. The material of the second member has the great modulus of elasticity. Therefore, in the case where a thickness of the second member is appropriately reduced, the second member can have an expected rigidity and an expected elastic restoring force, and a risk of a plastic deformation of the second member can be reduced, thereby further reducing a probability of wrinkling the flexible display panel. Or, the material of each of the second member and the third member has the great modulus of elasticity. Therefore, in the case where a thickness of each of the second member and the third member is appropriately reduced, each of the second member and third member can have an expected rigidity and an expected elastic restoring force, and a risk of a plastic deformation of each of the second member and the third member can be reduced, thereby further reducing the probability of wrinkling the flexible display panel.

In embodiments of the present disclosure, a material of the first member may be rubber, polyurethane or the like, and the material of the second member or the material of each of the second member and the third member may be a stainless steel, a polymer or the like. The polymer includes: PMMA (polymethyl methacrylate), PC (Polycarbonate) or PA (Polyamide).

In the embodiments of the present disclosure, a number and a size of each of the first and second members and a positional relationship between the first and second members or a number and a size of each of the first, second and third members and a positional relationship among the first, second and third members can be determined according to a number and a size of each of the foldable and non-foldable regions of the flexible display panel and a positional relationship between the foldable and non-foldable regions of the flexible display panel. For example, the flexible display panel may include a single foldable region and a single non-foldable region, and the foldable region is located on a side of the non-foldable region; or the flexible display panel may include a plurality of foldable regions and a plurality of non-foldable regions, and the plurality of foldable regions and the plurality of non-foldable regions are alternately arranged. For example, the flexible display panel includes one foldable region and two non-foldable regions, and the two non-foldable regions are located on both sides of the one foldable region, respectively. In the flexible display panel module according to the embodiments of the present disclosure, the first member and the second member or the first member, the second member and the third member of the supporting assembly have various structures, shapes, and connections.

In embodiments of the present disclosure, the flexible display panel module further includes: a flexible cover plate. The flexible cover plate is disposed on a side of the flexible display panel facing away from the supporting assembly and is connected with the flexible display panel.

Referring to FIGS. 1 to 8, a flexible display panel module according to embodiments of the present disclosure includes: a flexible display panel 1 including a foldable region 11 and a non-foldable region 10 outside the foldable region 11; and a supporting assembly 2 disposed on a side of the flexible display panel 1, connected with the flexible display panel 1. The supporting assembly 2 includes: a foldable portion 30 configured to support the flexible display panel 1 in the foldable region 11 of the flexible display panel 1; and a non-foldable portion 31 configured to support the flexible display panel 1 in the non-foldable region 10 of the flexible display panel 1. The foldable portion 30 of the supporting assembly 2 has a less rigidity than the non-foldable portion 31 of the supporting assembly 2.

Referring to FIGS. 1 to 8, in embodiments of the present disclosure, the supporting assembly 2 has a flat surface on a side of the supporting assembly 2 facing towards the flexible display panel 1. Further, the supporting assembly 2 has a flat surface on a side of the supporting assembly 2 facing away from the flexible display panel 1.

Referring to FIGS. 1 to 7, in embodiments of the present disclosure, an orthogonal projection of the foldable region 11, of the flexible display panel 1, on a plane parallel to the flexible display panel 1 is within an orthogonal projection of the foldable portion 30, of the supporting assembly 2, on the plane. For example, when viewed perpendicular to the flexible display panel 1, a size of the foldable region 11 of the flexible display panel 1 is less than or equal to a size of the foldable portion 30 of the supporting assembly 2.

Referring to FIGS. 1 to 7, in embodiments of the present disclosure, the foldable portion 30 of the supporting assembly 2 includes a first member 21; and the non-foldable portion 31 of the supporting assembly 2 includes a second member 22 connected with the first member 21, and a modulus of elasticity of the first member 21 is less than a modulus of elasticity of the second member 22, and is greater than a modulus of elasticity of the flexible display panel 1.

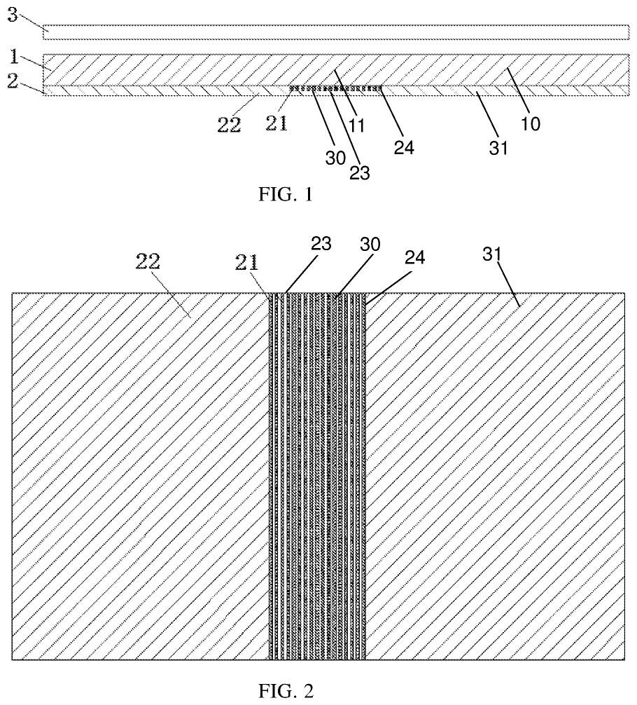

Referring to FIGS. 1 and 2, in embodiments of the present disclosure, the foldable portion 30 of the supporting assembly 2 further includes a third member 23 connected with the second member 22 and formed with a plurality of recesses 24, and each of the plurality of recesses 24 is filled with a single first member 21 and has a depth greater than or equal to a thickness of the single first member 21. Openings of the plurality of recesses 24 face towards the flexible display panel 1, the openings of the plurality of recesses 24 face away from the flexible display panel 1, or else, some of the openings of the plurality of recesses 24 face towards the flexible display panel 1, and the others of the openings of the plurality of recesses 24 face away from the flexible display panel 1. According to the embodiment shown in FIGS. 1 and 2, the third member 23 is integrated with the second member 22. For example, the third member 23 and the second member 22 are formed of a single plate.

As shown in FIG. 1, an embodiment of the present disclosure provides a flexible display panel module. The flexible display panel module includes a flexible display panel 1 and a supporting assembly 2. The supporting assembly 2 includes a second member 22 and a third member 23. The second member 22 and the third member 23 are integrated. For example, the second member 22 and the third member 23 are formed of a single plate. In addition, the second member 22 and the third member 23 as a whole serve as a base plate facing the non-foldable region 10 and the foldable region 11 and connected with the non-foldable region 10 and the foldable region 11. The third member 23 facing the foldable region 11 is formed with at least one recess 24, and each recess 24 is filled with a single first member 21. A thickness of the first member 21 is not greater than a depth of the recess 24.

Since the recess 24 is filled therein with the first member 21, it should be understood that a cavity of the recess 24 has the same shape as the first member 21 as shown in FIGS. 1 and 2.

As shown in FIG. 2, the second member 22 and the third member 23 as a whole are a plate. For example, the second member 22 and the third member 23 are formed of a single plate. The recess 24 is formed in a surface of the third member 23 facing the foldable region 11 by processes such as etching or laser processing, and then the first member 21 is filled in the recess 24. In order to ensure that the surface of the third member 23 is flat and prevent the third member 23 from interfering with another member connected with it, a thickness of the first member 21 is not greater than a depth of the recess 24. In embodiments of the present disclosure, the thickness of the first member 21 is equal to the depth of the recess 24.

A number, a shape, and an arrangement of the recesses 24 may be determined according to actual situations. In the present embodiment, the second member 22 and the third member 23 as a whole are a rectangular plate. The opening of the recess 24 in the surface of the third member 23 has a rectangular shape and the recess 24 extends over the entire third member 23 in a width direction of the rectangular plate composed of the second member 22 and the third member 23. The recesses 24 are arranged at intervals in a length direction of the rectangular plate. Of course, the shape of the opening of the recess 24 may also be any shape such as a triangular shape, a circular shape, an elliptical shape or any other irregular shape, and the recesses 24 may also be arranged in any other manner.

As shown in FIG. 1, in embodiments of the present disclosure, the openings of the recesses 24 face towards the flexible display panel 1, and the first member 21 and the third member 23 are connected with the flexible display panel 1 in the foldable region 11. As another example, the openings of the recesses 24 face away from the flexible display panel 1, and only the third member 23 is connected with the flexible display panel 1 in the foldable region 11. As a further example, some of the openings of the recesses 24 face towards the flexible display panel 1, and the others of the openings of the recesses 24 face away from the flexible display panel 1. The third member 23 and the first members 21 disposed in the recesses 24 facing towards the flexible display panel 1 are all connected with the flexible display panel 1 in the foldable region 11.

In the present embodiment, the first member 21 is connected with the third member 23 by filling the recess 24 of the third member 23 with the first member 21. In this way, the first member 21 is wrapped in the third member 23 so that the first member 21 is not easily separated from the third member 23, ensuring a stability of the connection.

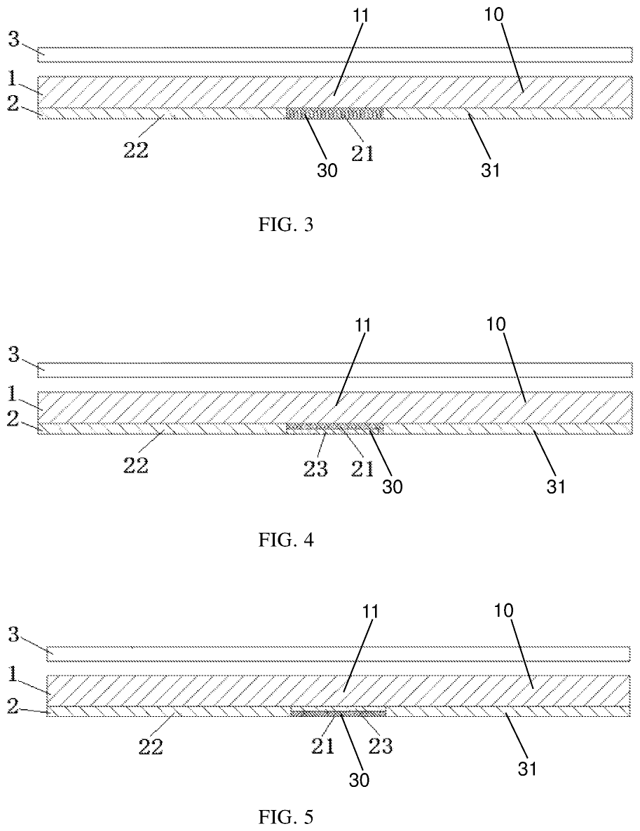

Referring to FIG. 3, in embodiments of the present disclosure, the first member 21 includes a plate having a first thickness and the second member 22 includes a plate having a second thickness; and the first member 21 is connected with the second member 22 in a direction parallel to the flexible display panel 1. The first member 21 is connected with the flexible display panel 1 in a direction perpendicular to the flexible display panel 1, and surfaces, respectively facing towards the flexible display panel 1 and facing away from the flexible display panel 1, of the first member 21 are flush with surfaces, respectively facing towards the flexible display panel 1 and facing away from the flexible display panel 1, of the second member 22, respectively.

As shown in FIG. 3, an embodiment of the present disclosure provides a flexible display panel module. The flexible display panel module includes a flexible display panel 1 and a supporting assembly 2. The supporting assembly 2 includes a first member 21 and a second member 22. The first member 21 includes a plate having a first thickness and the second member 22 includes a plate having a second thickness. The second member 22 faces the non-foldable region 10. The first member 21 is connected with the second member 22 in a direction parallel to the flexible display panel 1.

For example, the first member 21 is connected with the flexible display panel 1 in a direction perpendicular to the flexible display panel 1, and surfaces, respectively facing towards the flexible display panel 1 and facing away from the flexible display panel 1, of the first member 21 are flush with surfaces, respectively facing towards the flexible display panel 1 and facing away from the flexible display panel 1, of the second member 22, respectively. In other words, the first member 21 and the second member 22 have the same thickness and are connected to form the supporting assembly 2. Surfaces, respectively facing towards the flexible display panel 1 and facing away from the flexible display panel 1, of the supporting assembly 2 are planes, respectively.

For example, the flexible display panel 1 includes one foldable region 11 and two non-foldable regions 10, and the two non-foldable regions 10 are located on both sides of the one foldable region 11, respectively. Accordingly, the supporting assembly 2 includes one first member 21 and two second members 22. The two second members 22 are located on both sides of the one first member 21, respectively, and are connected with the one first member 21 in a direction parallel to the flexible display panel 1.

Referring to FIGS. 4 and 5, in embodiments of the present disclosure, the foldable portion 30 of the supporting assembly 2 further includes a third member 23, and a modulus of elasticity of a material of the first member 21 is less than a modulus of elasticity of a material of the third member 23, and the third member 23 includes a plate having a third thickness, the third member 23 and the first member 21 are stacked and connected to form a stacked assembly, the stacked assembly is connected with the flexible display panel 1 in a direction perpendicular to the flexible display panel 1, and the third member 23 is connected with the second member 22 in a direction parallel to the flexible display panel 1. Surfaces, respectively facing towards the flexible display panel 1 and facing away from the flexible display panel 1, of the stacked assembly are flush with surfaces, respectively facing towards the flexible display panel 1 and facing away from the flexible display panel 1, of the second member 22, respectively. In the embodiment shown in FIG. 4, the first member 21 is closer to the flexible display panel 1 than the third member 23, and the first member 21 is connected with the flexible display panel 1 in the foldable region 11. In the embodiment shown in FIG. 5, the third member 23 is closer to the flexible display panel 1 than the first member 21, and the third member 23 is connected with the flexible display panel 1 in the foldable region 11.

As shown in FIGS. 4 and 5, an embodiment of the present disclosure provides a flexible display panel module. The flexible display panel module includes a flexible display panel 1 and a supporting assembly 2. A difference between the flexible display panel module according to the present embodiment and the flexible display panel module according to the above embodiments is mainly described as below.

As shown in FIGS. 4 and 5, in the embodiment of the present disclosure, the supporting assembly 2 further includes a third member 23, and a modulus of elasticity of a material of the first member 21 is less than a modulus of elasticity of a material of the third member 23. The third member 23 includes a plate having a third thickness, the third member 23 faces the foldable region 11, the third member 23 and the first member 21 are stacked and connected to form a stacked assembly, the stacked assembly is connected with the flexible display panel 1 in the direction perpendicular to the flexible display panel 1, and the third member 23 is connected with the second member 22 in the direction parallel to the flexible display panel 1.

As shown in FIGS. 4 and 5, in the embodiment of the present disclosure, surfaces, respectively facing towards the flexible display panel 1 and facing away from the flexible display panel 1, of the stacked assembly are flush with surfaces, respectively facing towards the flexible display panel 1 and facing away from the flexible display panel 1, of the second member 22, respectively. In other words, the stacked assembly and the second member 22 have the same thickness and are connected to form the supporting assembly 2. Surfaces, respectively facing towards the flexible display panel 1 and facing away from the flexible display panel 1, of the supporting assembly 2 are planes, respectively.

In the present embodiment, as shown in FIG. 4, the first member 21 is closer to the flexible display panel 1 than the third member 23, and the first member 21 is connected with the flexible display panel 1 in the foldable region 11. Alternatively, as shown in FIG. 5, the third member 23 is closer to the flexible display panel 1 than the first member 21, and the third member 23 is connected with the flexible display panel 1 in the foldable region 11. A material of the third member 23 has a greater modulus of elasticity than a material of the first member 21, so that the third member 23 has a greater rigidity and a greater elastic restoring force. The third member 23 and the second member 22 are connected with each other so that it can be ensured that the flexible display panel 1 can be effectively supported by the second member 22 and the third member 23. The third member 23 can effectively support the flexible display panel 1 especially in the foldable region 11, increasing the impact resistance of the flexible display panel 1. In a possess of a change of the flexible display panel 1 from a folded state to an unfolded state, both the third member itself and the flexible display panel 1, especially in the foldable region 11 of the flexible display panel 1, can be sufficiently unfolded due to the greater elastic restoring force of the third member 23, preventing the flexible display panel 1 from wrinkling. As a result, the flexible display panel 1 always has a great flatness.

A sum of a thickness of the first member 21 and a thickness of the third member 23 is a thickness of the stacked assembly and the thickness of the stacked assembly is equal to a thickness of the second member 22. A specific value of each of the thickness of the first member 21 and the thickness of the third member 23 is not limited. The greater the thickness of the first member 21 is, the greater a flexibility of the stacked assembly is. The greater the thickness of the third member 23 is, the greater a rigidity and an elastic restoring force of the stacked assembly are. The thickness of the first member 21 and the thickness of the third member 23 can be appropriately designed according to actual requirements. In the embodiment of the present disclosure, the thickness of the first member 21 and the thickness of the third member 23 are equal to each other and each of the thickness of the first member 21 and the thickness of the third member 23 is half of the thickness of the second member 22.

In the embodiment of the present disclosure, a material of the third member 23 may be a stainless steel or a polymer or the like. The polymer includes: PMMA (polymethyl methacrylate), PC (Polycarbonate) or PA (Polyamide).

In the embodiment of the present disclosure, the first member 21 and the third member 23 may be made of the same material. For example, each of the first member 21 and the third member 23 is made of the stainless steel. The first member 21 and the third member 23 may be made of different materials. For example, the first member 21 is made of the stainless steel, and the third member 23 is made of the polymethyl methacrylate.

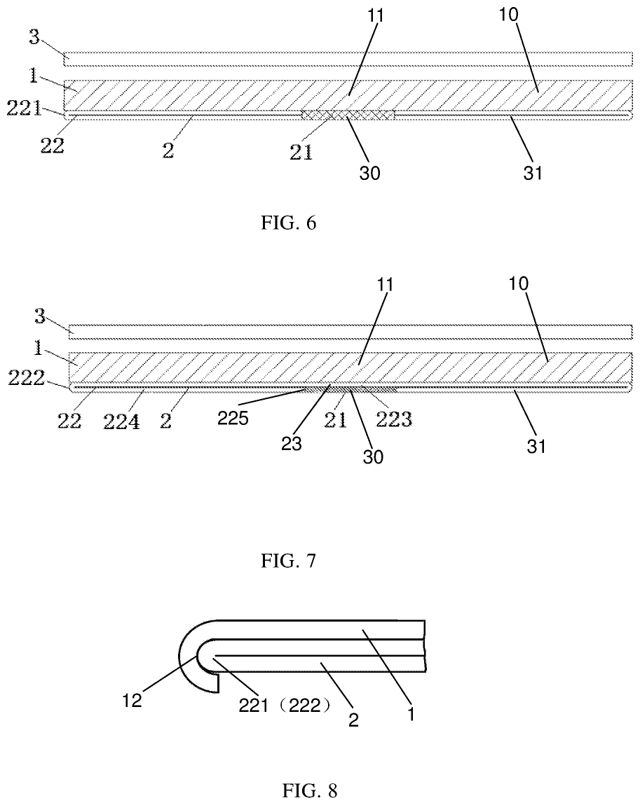

Referring to FIGS. 6, 7 and 8, in embodiments of the present disclosure, the second member 22 is formed by folding a plate, the second member 22 has one end connected with the first member 21 in a direction parallel to the flexible display panel 1, and the other folded end 221 having a curved external surface; and at least one end of the flexible display panel 1 has a groove 12 formed by bending the at least one end, and the other folded end 221 of the second member 22 is fitted in the groove 12. In the embodiment shown in FIG. 6, surfaces, respectively facing towards the flexible display panel 1 and facing away from the flexible display panel 1, of the first member 21 are flush with surfaces, respectively facing towards the flexible display panel 1 and facing away from the flexible display panel 1, of the second member 22, respectively.

As shown in FIG. 6, an embodiment of the present disclosure provides a flexible display panel module. The flexible display panel module includes a flexible display panel 1 and a supporting assembly 2. A difference between the flexible display panel module according to the present embodiment and the flexible display panel module according to the above embodiments is mainly described as below.

As shown in FIG. 6, in the flexible display panel module according to the embodiment of the present disclosure, the second member 22 is formed by folding a plate from one end of the plate to the other end of the plate. The second member 22 has one end connected with the first member 21 in the direction parallel to the flexible display panel 1, and the other folded end 221 having a curved external surface.

As shown in FIG. 8, in the embodiment of the present disclosure, at least one end of the flexible display panel 1 has a groove 12 formed by bending the at least one end. The groove 12 is a cavity formed by bending the end of the flexible display panel 1 backwards and having an arc-shaped inner wall. The folded end 221 of the second member 22 having the curved external surface is fitted in the groove 12. On one hand, since the folded end 221 has the curved external surface, it can be prevented from scratching the flexible display panel 1. On the other hand, since the folded end 221 is fitted in the groove, it can effectively support a portion of the flexible display panel 1 bent backwards.

In the present embodiment, a folding manner of the second member 22 is not particularly limited. Specifically, in the present embodiment, the second member 22 is formed by folding a plate in half once. In other words, the second member 22 includes two layers of plates, and the curved external surface of the folded end 221 is a curved surface formed at a folding line along which the plate is folded. Of course, in the present embodiment, the second member 22 may be formed by folding a plate in half a plurality of times. Or else, the second member 22 is formed by determining a plurality of folding lines at equal intervals in a length direction of the plate in advance, and then folding the plate respectively along the folding lines successively in a single direction or alternatively in forward and rearward directions, instead of repeatedly folding the plate in half. The number of times the plate is folded is determined according to requirements for the thickness of the second member 22.

Referring to FIG. 6, in the embodiment of the present disclosure, surfaces, respectively facing towards the flexible display panel 1 and facing away from the flexible display panel 1, of the first member 21 are flush with surfaces, respectively facing towards the flexible display panel 1 and facing away from the flexible display panel 1, of the second member 22, respectively. In other words, the first member 21 and the second member 22 have the same thickness and are connected to form the supporting assembly 2. Surfaces, respectively facing towards the flexible display panel 1 and facing away from the flexible display panel 1, of the supporting assembly 2 are planes, respectively.

Referring to FIGS. 7 and 8, in embodiments of the present disclosure, the foldable portion 30 of the supporting assembly 2 further includes a third member 23, and the third member 23 and the first member 21 are stacked, and the second member 22 and the third member 23 are formed by folding a single plate. The folded plate has two folded ends 222 which are aligned with two ends of the flexible display panel 1, respectively, and each of which has a curved external surface; the folded plate has a single-layer portion 223 serving as the third member 23, and double-layer portions 224 serving as the second member 22; a recess 225 is defined by the single-layer portion 223 and the double-layer portions respectively located on both sides of the single-layer portion 223, and the recess 225 is filled therein with the first member 21; at least one of the two ends of the flexible display panel 1 has a groove 12 formed by bending the at least one end, and one of the two folded ends 222 of the second member 22 is fitted in the groove 12; and surfaces, respectively facing towards the flexible display panel 1 and facing away from the flexible display panel 1, of a stacked assembly formed by stacking the first member 21 and the single-layer portion 223 are flush with surfaces, respectively facing towards the flexible display panel 1 and facing away from the flexible display panel 1, of each of the double-layer portions 224, respectively. The first member 21 is connected with the double-layer portions 224; and the first member 21 is closer to the flexible display panel 1 than the single-layer portion 223, or else, the single-layer portion 223 is closer to the flexible display panel 1 than the first member 21.

As shown in FIG. 7, in an embodiment of the present disclosure, the second member 22 and the third member 23 of the flexible display panel module are formed by folding a plate inwards from both ends of the plate. The folded plate faces the entire flexible display panel 1, and the folded plate has two folded ends 222 which are aligned with two ends of the flexible display panel 1, respectively, and each of which has a curved external surface.

As shown in FIG. 7, in an embodiment of the present disclosure, the folded plate has a single-layer portion 223 and double-layer portions 224. The single-layer portion 223 and the double-layer portions 224 face the foldable region 11 and the non-foldable region 10 of the flexible display panel 1 in the direction perpendicular to the flexible display panel 1, respectively. A recess 225 is defined by the single-layer portion 223 and the double-layer portions 224 respectively located on both sides of the single-layer portion 223, and the recess 225 is filled therein with the first member 21. The folded ends 222 are ends, facing away from the first member 21, of the double-layer portions 224.

As shown in FIG. 8, in the embodiment of the present disclosure, at least one of the two ends of the flexible display panel 1 has a groove 12 formed by bending the at least one end, and one of the two folded ends 222 of the second member 22 is fitted in the groove 12. On one hand, since the folded end 222 of the second member 22 has the curved external surface, it can be prevented from scratching the flexible display panel 1. On the other hand, since the folded end 222 of the second member 22 is fitted in the groove, it can effectively support a portion of the flexible display panel 1 bent backwards.

In the present embodiment, a folding manner of the plate is not particularly limited. Specifically, in the present embodiment, the second member 22 and the third member 23 are formed by folding a plate inwards from both ends of the plate once. The curved external surface of each of the two folded ends 222 of the folded plate is a curved surface formed at a folding line along which the plate is folded. Of course, the plate may also be folded a plurality of times. For example, each of the double-layer portions 224 is formed by determining a plurality of folding lines at equal intervals in a length direction of the plate in advance, and then folding a portion, on one end side, of the plate respectively along the folding lines successively in a single direction or alternatively in forward and rearward directions. The number of times the plate is folded is determined according to requirements for the thickness of the second member 22.

As shown in FIG. 7, in the embodiment of the present disclosure, surfaces, respectively facing towards the flexible display panel 1 and facing away from the flexible display panel 1, of a stacked assembly formed by stacking the first member 21 and the single-layer portion 223 are flush with surfaces, respectively facing towards the flexible display panel 1 and facing away from the flexible display panel 1, of each of the double-layer portions 224, respectively. In other words, the stacked assembly and the second member 22 have the same thickness and are connected to form the supporting assembly 2. Surfaces, respectively facing towards the flexible display panel 1 and facing away from the flexible display panel 1, of the supporting assembly 2 are planes, respectively.

As shown in FIG. 7, in the embodiment of the present disclosure, the first member 21 is connected with the double-layer portions 224. As shown in FIG. 2, the first member 21 is closer to the flexible display panel 1 than the single-layer portion 223, and the first member 21 is connected with the flexible display panel 1 in the foldable region 11. Alternatively, the single-layer portion 223 is closer to the flexible display panel 1 than the first member 21, and the single-layer portion 223 is connected with the flexible display panel 1 in the foldable region 11.

Referring to FIGS. 1 to 7, in embodiments of the present disclosure, the flexible display panel module further includes: a flexible cover plate 3. The flexible cover plate 3 is disposed on a side of the flexible display panel 1 facing away from the supporting assembly 2 and is connected with the flexible display panel 1.

Based on the same inventive concept, embodiments of the present disclosure further provide a display apparatus including the flexible display panel module according to any one of the embodiments of the present disclosure.

With the flexible display panel module and the display apparatus having the flexible display panel module according to the embodiments of the present disclosure, it is possible to prevent problems that the flatness of the flexible display panel of the flexible display apparatus is poor and the display failure of the flexible display panel is liable to occur after the flexible display panel is folded a plurality of times.

In the embodiments of the present disclosure, the modulus of elasticity of each of the first member and the second member of the supporting assembly is greater than the modulus of elasticity of the flexible display panel, or the modulus of elasticity of each of the first member, the second member and the third member is greater than the modulus of elasticity of the flexible display panel, so that the supporting assembly has a greater rigidity and a greater elastic restoring force than the flexible display panel. Thereby, the supporting assembly effectively supports the flexible display panel, helps the flexible display panel absorb a greater impact, increases an impact resistance of the flexible display panel, and facilitates maintaining a flatness and a resilience of the flexible display panel in an unfolded state. The modulus of elasticity of the first member is less than the modulus of elasticity of the second member or the modulus of elasticity of each of the second member and the third member, ensuring that the first member has a great flexibility. In the embodiments of the present disclosure, the first member may face the foldable region 11 of the flexible display panel, or each of the first member and the third member faces the foldable region 11 of the flexible display panel. In both cases, due to the presence of the first member, the portion of the supporting assembly facing the foldable region 11 of the flexible display panel has a certain flexibility, in addition to a certain rigidity and a certain elastic restoring force (i.e. a compromise between the rigidity and elastic restoring force and the flexibility is made). Thereby, in a process of repeatedly unfolding and folding the flexible display panel, a contact stress between the flexible display panel and the supporting assembly can be effectively reduced, the flexible display panel is prevented from being subjected to a large stress in the folding process, a plastic deformation of the flexible display panel in the foldable region 11 is reduced, a probability of damaging the flexible display panel is decreased, and a display failure of the flexible display panel is prevented.

Further, in a possess of a change of the flexible display panel from a folded state to an unfolded state, the flexible display panel can be prevented from wrinkling in the non-foldable region 10 since the second member has a great resistance to deformation, and the second member itself and the flexible display panel can be sufficiently unfolded due to the large elastic restoring force of the second member, preventing the flexible display panel from wrinkling in the foldable region 11. As a result, the flexible display panel always has a great flatness. The material of the second member has the great modulus of elasticity. Therefore, in the case where a thickness of the second member is appropriately reduced, the second member can have an expected rigidity and an expected elastic restoring force, and a risk of a plastic deformation of the second member can be reduced, thereby further reducing a probability of wrinkling the flexible display panel. Or else, the material of each of the second member and the third member has the great modulus of elasticity. Therefore, in the case where a thickness of each of the second member and the third member is appropriately reduced, each of the second member and third member can have an expected rigidity and an expected elastic restoring force, and a risk of a plastic deformation of each of the second member and the third member can be reduced, thereby further reducing the probability of wrinkling the flexible display panel.

The terms “first” and “second” are used for only descriptive purposes and should not to be construed as indicating or implying a relative importance or implicitly indicating the numbers of technical features indicated by them. Thus, a feature defined with the term “first” or “second” may include one or more of the features either explicitly or implicitly. In the description of the present disclosure, “plurality of” means two or more unless otherwise described.

In the description of the present disclosure, it should be noted that the term “connected” should be understood broadly unless otherwise specifically prescribed and defined. For example, the term “connected” may means “fixedly connected”, “detachably connected, “integrally connected”, “directly connected” or “indirectly connected through an intermediate medium”. The specific meanings of the above term in the present disclosure can be understood by those skilled in the art according to specific situations.

In the description, specific features, structures, materials or characteristics may be combined in appropriate manners in any one or more embodiments or examples.

Although some exemplary embodiments of the present disclosure have been shown and described above, it would be appreciated by a person skilled in the art that many modifications or changes may be made therein without departing from the principle and spirit of the present disclosure, the scope of which is defined in the appended claims and their equivalents.

What is claimed is:

1. A flexible display panel module comprising:
a flexible display panel comprising a foldable region and a non-foldable region outside the foldable region; and
a supporting assembly disposed on a side of the flexible display panel, connected with the flexible display panel, and comprising: a foldable portion configured to support the flexible display panel in the foldable region of the flexible display panel; and a non-foldable portion configured to support the flexible display panel in the non-foldable region of the flexible display panel,
wherein the foldable portion of the supporting assembly has a less rigidity than the non-foldable portion of the supporting assembly.

2. The flexible display panel module of claim 1, wherein:
the supporting assembly has a flat surface on a side of the supporting assembly facing towards the flexible display panel.

3. The flexible display panel module of claim 1, wherein:
the supporting assembly has a flat surface on a side of the supporting assembly facing away from the flexible display panel.

4. The flexible display panel module of claim 1, wherein:
an orthogonal projection of the foldable region of the flexible display panel on a plane parallel to the flexible display panel is within an orthogonal projection of the foldable portion of the supporting assembly on the plane.

5. The flexible display panel module of claim 1, wherein:
the foldable portion of the supporting assembly comprises a first member; and
the non-foldable portion of the supporting assembly comprises a second member connected with the first member, and a modulus of elasticity of the first member is less than a modulus of elasticity of the second member, and is greater than a modulus of elasticity of the flexible display panel.

6. The flexible display panel module of claim 5, wherein:
the foldable portion of the supporting assembly further comprises a third member connected with the second member and formed with a plurality of recesses, and each of the plurality of recesses is filled with one said first member and has a depth greater than or equal to a thickness of the first member.

7. The flexible display panel module of claim 6, wherein:
openings of the plurality of recesses face towards the flexible display panel,
the openings of the plurality of recesses face away from the flexible display panel, or
some of the openings of the plurality of recesses face towards the flexible display panel, and the others of the openings of the plurality of recesses face away from the flexible display panel.

8. The flexible display panel module of claim 5, wherein:
the first member comprises a plate having a first thickness and the second member comprises a plate having a second thickness; and
the first member is connected with the second member in a direction parallel to the flexible display panel.

9. The flexible display panel module of claim 6, wherein:
the third member is integrated with the second member.

10. The flexible display panel module of claim 9, wherein:
the first member is connected with the flexible display panel in a direction perpendicular to the flexible display panel, and surfaces, respectively facing towards the flexible display panel and facing away from the flexible display panel, of the first member are flush with surfaces, respectively facing towards the flexible display panel and facing away from the flexible display panel, of the second member, respectively.

11. The flexible display panel module of claim 5, wherein:
the foldable portion of the supporting assembly further comprises a third member, and a modulus of elasticity of a material of the first member is less than a modulus of elasticity of a material of the third member, and
the third member comprises a plate having a third thickness, the third member and the first member are stacked and connected to form a stacked assembly, the stacked assembly is connected with the flexible display panel in a direction perpendicular to the flexible display panel, and the third member is connected with the second member in a direction parallel to the flexible display panel.

12. The flexible display panel module of claim 11, wherein:
surfaces, respectively facing towards the flexible display panel and facing away from the flexible display panel, of the stacked assembly are flush with surfaces, respectively facing towards the flexible display panel and facing away from the flexible display panel, of the second member, respectively.

13. The flexible display panel module of claim 11, wherein:
the first member is closer to the flexible display panel than the third member, and the first member is connected with the flexible display panel in the foldable region; or
the third member is closer to the flexible display panel than the first member, and the third member is connected with the flexible display panel in the foldable region.

14. The flexible display panel module of claim 5, wherein:
the second member is formed by folding a plate,
the second member has one end connected with the first member in a direction parallel to the flexible display panel, and the other folded end having a curved external surface; and
at least one end of the flexible display panel has a groove formed by bending the at least one end, and the other folded end of the second member is fitted in the groove.

15. The flexible display panel module of claim 14, wherein:
surfaces, respectively facing towards the flexible display panel and facing away from the flexible display panel, of the first member are flush with surfaces, respectively facing towards the flexible display panel and facing away from the flexible display panel, of the second member, respectively.

16. The flexible display panel module of claim 5, wherein:
the foldable portion of the supporting assembly further comprises a third member, and the third member and the first member are stacked, and
the second member and the third member are formed by folding a single plate.

17. The flexible display panel module of claim 16, wherein:
the folded plate has two folded ends which are aligned with two ends of the flexible display panel, respectively, and each of which has a curved external surface;
the folded plate has a single-layer portion serving as the third member, and double-layer portions serving as the second member;
a recess is defined by the single-layer portion and the double-layer portions respectively located on both sides of the single-layer portion, and the recess is filled with the first member;
at least one of the two ends of the flexible display panel has a groove formed by bending the at least one end, and one of the two folded ends of the second member is fitted in the groove; and
surfaces, respectively facing towards the flexible display panel and facing away from the flexible display panel, of a stacked assembly formed by stacking the first member and the single-layer portion are flush with surfaces, respectively facing towards the flexible display panel and facing away from the flexible display panel, of each of the double-layer portions, respectively.

18. The flexible display panel module of claim 17, wherein:
the first member is connected with the double-layer portions; and
the first member is closer to the flexible display panel than the single-layer portion, or the single-layer portion is closer to the flexible display panel than the first member.

19. The flexible display panel module of claim 1, further comprising:
a flexible cover plate which is disposed on a side of the flexible display panel facing away from the supporting assembly and is connected with the flexible display panel.

20. A display apparatus comprising:
the flexible display panel module of claim 1.
